(19) United States
(12) Patent Application Publication
(10) Pub. No.: US 2026/0253480 A1
(43) Pub. Date: Aug. 27, 2026

(54) ARRANGEMENT AND METHOD FOR LOCATING A TRANSMITTER

(71) Applicant: Dräger Safety AG & Co. KGaA, Lübeck (DE)

(72) Inventors: Folke Will, Lübeck (DE); Dominik Gaus, Lübeck (DE); Nele Kirsch, Lübeck (DE)

(21) Appl. No.: 19/548,510

(22) Filed: Feb. 24, 2026

(30) Foreign Application Priority Data
Feb. 27, 2025 (DE) 102025107460.7
Mar. 17, 2025 (DE) 102025110223.6

(51) Int. Cl. G08B 21/02; G08B 7/06

(52) U.S. Cl. CPC G08B 21/02; G08B 7/06

(57) ABSTRACT

Means of which a searching person is assisted in finding a person to be rescued, as well as to a method using such an arrangement, are provided. The person to be rescued wears an alarm detector and a transmitter on their body. The alarm detector detects an emergency and generates a rescue signal, and the transmitter then issues a sequence of alarm signals. The searching person wears a receiver and an alarm unit on his/her body. For each alarm signal an attenuation on the path from the transmitter to the receiver is determined. Depending on the determined attenuation, one of z given possible alarm intensities is selected in each case, z≥2. The alarm unit issues an acoustic and/or haptic alarm with the selected alarm intensity.

### CROSS-REFERENCE TO RELATED APPLICATIONS

This application claims the priority of German Patent Application No. 102025107460.7, filed on Feb. 27, 2025, and titled “ARRANGEMENT AND METHOD FOR LOCATING A TRANSMITTER”; and German Patent Application No. 102025110223.6 filed on Mar. 17, 2025, and titled “ARRANGEMENT AND METHOD FOR LOCATING A TRANSMITTER”, each of which is hereby incorporated by reference in its entirety for all nonlimiting purposes.

### TECHNICAL FIELD

The present disclosure relates to an arrangement and a method for assisting a person in locating a transmitter. The transmitter sends out a sequence of alarm signals, and a receiver receives at least one alarm signal.

### BACKGROUND

The task of using such an arrangement and method arises, for example, while a firefighter or other person is in a spatial area that is dangerous for humans, gets into an emergency situation and therefore needs to be found and subsequently rescued. This person to be found carries the transmitter with him/her. In many cases, the search for this person is made difficult by heavy smoke and/or poor lighting conditions and/or loud ambient noise and/or because the person is hidden or buried.

### SUMMARY

The present disclosure is based on the object of providing an arrangement and a method which make it possible to locate a transmitter, wherein the transmitter is worn by a person to be found, and the arrangement and the method make it possible to locate the transmitter better than known arrangements and methods even in the presence of heavy smoke and/or poor lighting conditions.

The object is achieved by an arrangement having the features of the claims and by a method having the features of the claims. Advantageous example embodiments are specified in the dependent claims. Insofar as they are reasonable, advantageous designs of the arrangement according to the present disclosure are also advantageous designs of the method according to the present disclosure, and vice versa.

The arrangement according to the present disclosure comprises a transmitter. While the arrangement is used, the transmitter is assigned to a person and can be worn by that person on his/her body. The person to whom the transmitter is assigned is hereinafter referred to as the “person to be found” (a first person).

The arrangement also comprises a rescue signal generator. The rescue signal generator is configured to generate a rescue signal and to cause the rescue signal to be transmitted to the transmitter, either via cable or radio waves. In one example embodiment, the person to be found wears the rescue signal generator on his/her body in addition to the transmitter, but this is not necessary. Preferably, the rescue signal generator is designed to be worn on the body of the person to be found.

The transmitter is configured to receive and process the rescue signal. The transmitter is configured as follows: in response to receiving the rescue signal, the transmitter generates a sequence of alarm signals and transmits this sequence.

While the arrangement is used, the person wearing the transmitter is the person to be found, and the sequence of alarm signals makes it easier to find the person to be found. The desired situation is, of course, that the person to be found is wearing the transmitter on his/her body, but no emergency occurs and for this reason the transmitter does not receive a rescue signal and does not generate and transmit a sequence of alarm signals.

Furthermore, the arrangement according to the present disclosure comprises a receiver. The receiver is configured to receive an alarm signal that the transmitter has generated and sent as part of the sequence. Whether the receiver actually receives the alarm signal usually depends on how the receiver is positioned and oriented relative to the transmitter and whether the alarm signal is shielded and/or reflected and/or otherwise significantly attenuated on its way from the transmitter to the receiver. It is therefore possible for the receiver to only receive some alarm signals of the transmitted sequence.

The receiver is configured to measure the respective received signal strength for each received alarm signal. The received signal strength is the signal strength with which this alarm signal reaches the receiver. Typically, the receiver moves relative to the transmitter, so the received signal strength can vary from alarm signal to alarm signal. As a rule, the received signal strength is less than or at most equal to the transmitted signal strength, which is the signal intensity with which the transmitter sent out this alarm signal. This is because the alarm signal is usually attenuated on its way from the transmitter to the receiver or, at best, transmitted without attenuation, but not amplified. Preferably, the receiver can also be worn by a person on his/her body.

An alarm unit of the arrangement is designed to be worn by a person on his/her body. The alarm unit can issue an acoustic and/or haptic alarm. To issue a haptic alarm, the alarm unit preferably generates vibrations. In many cases, the generated vibrations can also be perceived acoustically, meaning the alarm is both haptic and acoustic. The alarm unit is configured as follows: the person wearing the alarm unit on his/her body perceives an alarm that has been issued. The person with the alarm unit is hereinafter referred to as a “searching person”.

In a preferred use of the arrangement according to the present disclosure, the same searching person wears both the receiver and the alarm unit on his/her body. This person is not the person who is wearing the transmitter and preferably the rescue signal generator on his/her body, and is therefore not the person to be found. Rather, in a preferred application, an or the searching person searches for the person to be found.

Several possible alarm intensities are specified. The number of possible alarm intensities is denoted by z, where z≥2, preferably z≥4. These z predefined possible alarm intensities influence the perception of the alarm by the searching person wearing the alarm unit. A person wearing the alarm unit on his/her body can acoustically and/or haptically distinguish between the z different alarm intensities and from the situation in which the alarm unit is not currently issuing an alarm. The alarm unit can be controlled, specifically by a signal-processing controller (control unit) of the arrangement according to the present disclosure. Preferably, the controller comprises a processor and a memory on which a computer program is stored. Executing the computer program causes the controller to receive and process signals and to generate outputs, in particular control outputs. In one example embodiment, the searching person also wears the controller on his/her body. Depending on the control, the alarm unit is configured to issue the alarm in one of the z predefined possible alarm intensities. As a rule, the alarm unit varies the alarm intensity with which the alarm is issued, over time, depending on the control.

The method according to the present disclosure is performed while a person to be found is wearing the transmitter and preferably also the rescue signal generator on his/her body and a searching person is wearing the alarm unit and preferably also the receiver and/or the controller on his/her body. The person to be found and the searching person are two different persons.

A signal-processing evaluation unit of the arrangement is configured to determine an attenuation for an alarm signal received by the receiver, this attenuation acting on the alarm signal while the alarm signal travels its path from the transmitter to the receiver. In one implementation, the evaluation unit comprises a processor and a memory on which a computer program is stored. While the computer program is executed, the evaluation unit receives and processes signals. In one implementation, the evaluation unit is a component of the controller. The attenuation may vary from alarm signal to alarm signal of the transmitted sequence, in particular because the receiver moves relative to the transmitter. In order to determine the attenuation, the evaluation unit uses the measured received signal strength. In one implementation, the attenuation is the difference between the transmitted signal strength and the received signal strength, specifically in particular if the signal intensity is a logarithmic measure. The evaluation unit can select one of the z possible alarm intensities. For this selection, the evaluation unit uses the determined attenuation of the received alarm signal. Preferably, the alarm intensity is greater, i.e. the alarm is stronger, the smaller the attenuation, i.e. the stronger the signal intensity of the received alarm signal.

The arrangement is configured as follows, and the method comprises the following steps: the event that the receiver receives an alarm signal sent by the transmitter triggers the following automatically executed steps:
The receiver measures the received signal strength of this alarm signal.
The attenuation that acts on the alarm signal is determined. To determine the attenuation, the measured received signal strength is used.
One of the z possible alarm intensities is selected. The determined attenuation is used for this selection.
The alarm unit is controlled. In response to the control, the alarm unit issues an alarm or, if necessary, modifies an alarm that has already been issued. The control causes the alarm to be issued with the selected alarm intensity.
In one example embodiment, if the attenuation is greater than an upper attenuation threshold, no alarm intensity will be selected and no alarm issued, or the issuance of an alarm is stopped. Preferably, the issuance of the alarm is also stopped if within a period of a prespecified minimum duration no alarm signal reaches the receiver.

Note: The wording is used that a sensor is configured to measure a physical variable, for example a signal intensity. This wording means that the sensor may measure the physical variable directly, or at least one other variable that correlates with the variable to be measured. Therefore, the variable or one measured other variable or the combination of the measured other variables together are an indicator for the physical variable to be measured. The measurement provides at least one value for the physical variable sought.

In many cases, the present disclosure makes it easier for a searching person, who is wearing the alarm unit and preferably the receiver on his/her body, to find the person to be found, the person to be found wearing the transmitter and preferably the rescue signal generator on his/her body. This advantage is often achieved even if the person to be rescued, with the transmitter and rescue signal generator, is difficult to find, for example due to heavy smoke, poor lighting conditions, high noise levels, or because the person to be found is lying on the ground or is buried or is hidden behind an object. It is also possible that the person to be found is moving or is being moved.

The rescue signal generator or a person using the rescue signal generator detects the event that a person wearing the transmitter and preferably the rescue signal generator on his/her body needs to be rescued, i.e. now is a person to be found and rescued. The detection of the event that the person needs to be rescued, i.e. the reception of the rescue signal, automatically triggers the step in which the transmitter generates and sends the sequence of alarm signals. In advantageous example embodiments, the present disclosure eliminates the need for another person or a stationary monitoring device to monitor the person with the transmitter in order to determine whether this person needs to be rescued. Such monitoring is often not possible at all or at least not sufficiently reliably.

The alarm unit can be worn by a person on his/her body, namely by the searching person. As a result, the searching person is often able to perceive an alarm being issued and relate the alarm to himself/herself with greater certainty than if the alarm were issued by a remote alarm unit. Because the searching person wears the alarm unit on his/her body, the alarm unit moves with the searching person.

Preferably, the searching person wearing the alarm unit on his/her body is also wearing the receiver. The receiver therefore moves along with the searching person. The measured attenuation is therefore usually also the attenuation that the alarm signal experiences on its way from the person to be found, with the transmitter, to the searching person, with the receiver.

The alarm unit of the arrangement according to the present disclosure is configured to issue an alarm acoustically and/or haptically. This way of issuing an alarm does not require—in contrast to a visually issued alarm—the following: The searching person must look at a display surface which issues an alarm in a visually perceptible form. Such a visual output could distract the person searching. In addition, in some situations such a visual output may not be perceptible, for example in the presence of heavy smoke. In some cases, a visual alarm unit consumes more electrical energy than an alarm unit that issues an acoustic and/or haptic alarm. It is possible for the alarm unit to be additionally configured to issue a visual alarm, but this is not necessary.

The following alternative to the present disclosure would be conceivable: in response to the receiver having received an alarm signal, the alarm unit issues an alarm in acoustic and/or haptic form, the alarm, however, does not depend on an alarm intensity. The alarm therefore in particular does not depend on any attenuation that an alarm signal experiences on its way from the transmitter to the receiver. Information about a distance between transmitter and receiver or a direction or position of the transmitter relative to the receiver is output in another way, for example visually. This conceivable alternative also requires that a person using the receiver must perceive visual information in addition to the acoustic or haptic alarm. The disadvantages of visual information were described in the previous paragraph.

The present disclosure also does not require that the receiver be moved relative to the transmitter in order to determine the direction or distance to the transmitter.

The present disclosure can be used in combination with a camera for light in the visible range or with a thermal imaging camera, often also called an infrared camera. Even in the presence of heavy smoke, the outline of a person can often be recognized in a thermal imaging camera image. However, the present disclosure makes it easier to find the transmitter even without such a camera or if the person is hidden behind or under an object.

According to the present disclosure, the alarm unit issues the alarm at one of z predetermined possible alarm intensities. The current alarm intensity depends at least on the determined attenuation of the last received alarm signal, optionally on the respective attenuation of several alarm signals. If the receiver moves relative to the transmitter, the alarm intensity will usually change. The searching person, who is wearing the alarm unit on his/her body, usually perceives these temporally changing alarm intensities. This usually helps the searching person to know whether he/she is getting closer to the person to be found, with the transmitter, or whether he/she is moving away from that transmitter. Often, the attenuation is lower the shorter the distance is between the transmitter and the receiver. In one example embodiment, the controller stops issuing an alarm if the most recent alarm signal is sufficiently attenuated. This is often an indication that the searching person is moving away from the person to be found.

According to the present disclosure, the arrangement comprises a rescue signal generator which is assigned to a person to be found. This person to be found wears the transmitter. The rescue signal generator is configured to generate the rescue signal and to cause the generated rescue signal to be transmitted to the transmitter. Different embodiments of this rescue signal generator are possible.

In one example embodiment, the arrangement comprises an alarm detector. The alarm detector is assigned to the person to whom the transmitter has also been assigned. Preferably, the person wears the alarm detector on his/her body in addition to the transmitter. However, the alarm detector can also be located spatially remote from the assigned person and, for example, comprise an image capturing device and an image evaluation unit. The image evaluation unit is configured to automatically evaluate images from the image recording device and thus detect whether or not an emergency has occurred.

The alarm detector is configured to monitor the assigned person with the transmitter. During monitoring, the alarm detector checks whether there is any indication that the assigned person needs to be rescued. For example, the person does not move for a period of a specified minimum duration or moves less than a specified lower movement threshold, or a person's measured vital parameter is outside an acceptable range. The frequency and amplitude of one's own breathing as well as the heart rate and body temperature are examples of vital parameters. It is also possible that the person himself/herself activates the alarm detector or the rescue signal generator.

The event that the alarm detector detects an indication that the assigned person with the transmitter needs to be rescued causes the controller to trigger the following steps: The rescue signal generator generates the rescue signal and causes the rescue signal to be transmitted to the transmitter. This transmission can be carried out via cable and/or radio waves.

Some embodiments concerning the alarm detector increase the dependability (reliability) of the rescue signal actually being generated and transmitted if an emergency occurs. It is not necessary for the person with the transmitter or another person or even an image processing unit to notice that the emergency has occurred. In some cases, the person to be found is hidden behind or under an object and is therefore difficult or impossible to detect.

It is also possible for the rescue signal generator to include an operating unit in addition to the alarm detector or instead of the alarm detector. This operating unit can be operated manually. Operating this operating unit causes the rescue signal to be generated and transmitted to the transmitter. If the person to be found is wearing the operating unit, in this example embodiment the person with the transmitter can generate the rescue signal himself/herself and thereby cause the transmitter to generate and issue the sequence of alarm signals.

Another alternative is the following: The person with the transmitter is monitored by a remote control center. Preferably, a camera generates images of a spatial area where the person with the transmitter is located. The camera can generate images in the visible light range or infrared images (thermal images). The images are transmitted to the control center and displayed visually there. A person at the control center looks at the images output and decides whether the person with the transmitter needs to be found and rescued. The person at the control center causes the rescue signal generator to generate and transmit the rescue signal. The rescue signal generator can be arranged at the control center. For example, the person in the control center operates a corresponding operating unit. This rescue signal is preferably transmitted from the control center to the transmitter, either via cable and/or via radio waves, for example to at least part of the route via a public mobile network.

In one example embodiment, the transmitter transmits each alarm signal with a constant prespecified transmission signal intensity, in an alternative embodiment described below, however, with a varying transmission signal intensity.

In an example embodiment, the transmitter is configured to generate at least one alarm signal, preferably each alarm signal, as follows: The alarm signal comprises information about the transmission signal intensity. The attenuation that acts on the alarm signal is determined depending on the measured received signal strength and the transmitted signal strength, via which information is contained in the transmitted and received alarm signal. For example, the attenuation is the difference between the received signal strength and the transmitted signal strength.

This example embodiment eliminates the need to prespecify a transmission signal intensity to the receiver or the evaluation unit. This example embodiment makes it easier in some cases to adapt the arrangement according to the present disclosure to given specifications. Sometimes a maximum signal intensity with which a signal is transmitted is prespecified, sometimes in addition to or instead of this a minimum signal intensity is prespecified. For example, the person wearing the transmitter can specify a maximum transmission signal intensity.

In a development of this example embodiment, the transmission signal intensity is varied automatically. The transmitter is configured to set a transmission signal intensity for at least one alarm signal, preferably for each alarm signal in the sequence, for example using a random number generator or depending on a prespecified temporal progression of the transmission signal intensity. Overall, the alarm signals of the sequence are thus transmitted with at least two different transmission signal intensities, preferably with at least ten different transmission signal intensities, in particular with at least 50 different transmission signal intensities.

The example embodiment in which the transmission signal intensity is varied in particular has the following advantage: a possible influence of the transmission signal intensity on the attenuation and thus on the currently used alarm intensity is compensated for to a certain extent by averaging over the transmission signal intensities.

In a development of this example embodiment, the transmitter comprises its own voltage supply unit and a sensor for the current charge state of this voltage supply unit. During use, the charge state usually decreases. The transmitter is configured as follows: the transmitter uses a maximum transmission signal intensity and transmits each alarm signal with a transmission signal intensity that is at most equal to the maximum transmission signal intensity. An initial maximum transmission signal intensity is prespecified, for example depending on a design of the transmitter. The transmitter automatically changes the maximum transmission signal intensity used as follows: the maximum transmission signal intensity is lower, the lower the measured charge state of the transmitter's own voltage supply unit. In the case of a lower charge state, the transmitter therefore consumes less electrical energy, and the transmitter can be used for longer than if the maximum transmission signal intensity always remained the same as the initial maximum transmission signal intensity.

In one example embodiment, the arrangement comprises a further transmitter and a further receiver and preferably a further alarm unit. In one implementation, the arrangement comprises a communication unit, the receiver and the further transmitter being two components of this communication unit. The further transmitter is configured as follows: the event that the receiver receives an alarm signal triggers the step that the further transmitter sends another alarm signal. Preferably, the further transmitter sends out as many alarm signals as the receiver receives. The further receiver is configured to receive a further alarm signal sent by the further transmitter. Of course, it is possible that a further alarm signal sent out does not reach the further receiver. The further receiver is configured to measure the received signal strength, which is the signal intensity with which the further alarm signal reaches the further receiver.

In one application, the searching person wears the further transmitter on his/her body. For example, said person wears the communication unit on his/her body. A third person, who is also a searching person, wears the further receiver and preferably the further alarm unit on his/her body. The further alarm unit can alert the third person. The receiver and the further transmitter act together as a relay station. This example embodiment makes it easier for the third person to find the searching person and then the person to be found, specifically even if the further receiver does not receive an alarm signal from the transmitter worn by the person to be found.

It is possible that the transmission signal intensity with which the further transmitter sends out the further alarm signal is fixedly prespecified, for example as a temporal progression of the transmission signal intensities.

Another implementation can be combined with the implementation just described, in which at least one, preferably each, alarm signal of the sequence includes information about the transmission signal intensity with which this alarm signal is transmitted. According to the other implementation, the transmission signal intensity with which the further transmitter transmits the further alarm signal is equal to the transmission signal intensity with which the transmitter transmitted the alarm signal. The reception of this alarm signal by the receiver triggers the step of the further transmitter sending the further alarm signal. Information about the transmission signal intensity with which the further alarm signal is transmitted is included in the received alarm signal.

In one example embodiment, each event that the receiver receives an alarm signal again triggers the steps of
the receiver measuring the received signal strength,
the evaluation unit determining the attenuation for this received alarm signal, and
the evaluation unit selecting an alarm intensity depending on the determined attenuation.

In an example embodiment, however, the evaluation unit is configured to calculate an averaged attenuation. The averaged attenuation is an average of the attenuations of several received alarm signals, preferably of several alarm signals received immediately after one another. For example, a number N is specified, and the evaluation unit averages the attenuations of the most recent N alarm signals received. Alternatively, the duration of a sliding time window is prespecified, the sliding time window ending at the last sampling time of the receiver. The evaluation unit is configured to average the attenuations of all alarm signals received by the receiver in the sliding time window. The evaluation unit selects the currently used alarm intensity depending on the result of this averaging, i.e. depending on an average attenuation.

It is possible for the evaluation unit to calculate the arithmetical mean or a weighted mean of the attenuations. For example, the weighting factor for attenuation is greater the shorter the time since the alarm signal was received, i.e. the more recent the alarm signal is. In an example embodiment, however, the evaluation unit calculates the median over the last attenuations. The median is less sensitive to outliers than is the arithmetical mean.

The example embodiment whereby the evaluation unit selects the current alarm intensity depending on a weighted mean or median often results in the alarm intensity varying less over time. A rapidly temporally varying alarm intensity is often perceived by a user as annoying and unhelpful.

According to the present disclosure, the evaluation unit is configured to determine the attenuation experienced by the alarm signal and to select one of the possible alarm intensities depending on the attenuation determined. The controller can control the alarm unit in such a way that the following occurs: The alarm unit issues the alarm with the selected alarm intensity. In one example embodiment, the alarm issued comprises an acoustically perceptible alarm. In one implementation, the alarm intensity also depends on ambient noise. For example, the controller receives a signal from a noise level sensor, said noise level sensor measuring the intensity (level) of ambient noise. With the same attenuation, the alarm intensity is greater the louder the measured ambient noise is. This example embodiment reduces the risk of an acoustic alarm being overlooked due to loud ambient noise. At the same time, in many cases an alarm is not issued louder than absolutely necessary.

Typically, the transmitter uses a transmission protocol to send the sequence of alarm signals, preferably via radio waves. The transmitter preferably uses a standardized transmission protocol. Often, the standard used specifies a maximum transmission power with which signals are transmitted according to the corresponding transmission protocol. Particularly preferably, a standardized transmission protocol is used for the present disclosure which specifies a maximum transmission power of at most 100 mW (20 dBm), particularly preferably of at most 50 mW (17 dBm).

The example embodiment whereby a standardized transmission protocol with a maximum transmission power of 100 mW is used has the following advantage: as a rule, the transmitter is not connected to a stationary voltage supply network but has its own voltage supply unit. It is therefore advantageous that the transmission of alarm signals consumes relatively little electrical energy. This desired effect is achieved with a relatively low maximum transmission power.

The example embodiment whereby a transmission protocol with a relatively low transmission power is used results in a relatively short range, especially if there is at least one wall or other shielding object between the transmitter and the receiver. Such a short range is often advantageous in particular in the following situation: the searching person with the alarm unit is already near the transmitter before the receiver receives an alarm signal from the transmitter for the first time. However, the searching person with the alarm unit is still unable to perceive and locate the person to be found who is wearing the transmitter on his/her body, for example due to heavy smoke or poor lighting conditions or because the person to be found is hidden behind an object or buried under an object. The example embodiment just described makes it easier for the searching person to determine whether he/she is moving towards the transmitter or away from the transmitter or whether the distance to the transmitter remains the same, specifically in particular if the distance between the transmitter and the receiver is only a few meters. Even at such a short distance, the alarm intensity often varies while the searching person moves relative to the person to be found.

Examples of such standardized transmission protocols with a relatively low transmission power are:
Bluetooth Low Energy (BLE-maximum transmission power 10 mW),
Ultra-Wide Band (UWB-maximum transmission power less than 5 mW),
Wi-Fi configurations,
wireless LAN configurations.

The example embodiment just described, in which a transmission protocol with a relatively low maximum transmission power is used, can be combined with an example embodiment in which the person to be found wears a further alarm unit on his/her body in addition to the transmitter. The event that the rescue signal generator generates and transmits a rescue signal triggers the following two events:
the transmitter sends out the sequence of alarm signals.
the further alarm unit generates an acoustically and/or visually perceptible alarm.

This acoustically and/or visually perceptible alarm guides the searching person, who is wearing the acoustic or haptic alarm unit and preferably the receiver on his/her body, to the proximity of the person to be found with the transmitter. The searching person is able to perceive, with at least one of his/her five senses, the alarm issued by the further alarm unit worn by the person to be found on his/her body. The example embodiment with the short-range transmission protocol then leads the searching person with the receiver to the person to be found with the transmitter.

According to the present disclosure, the evaluation unit selects one of the z possible alarm intensities and issues the alarm with the selected alarm intensity. The alarm intensity often changes if the receiver is moved relative to the transmitter. In order to select the alarm intensity, the evaluation unit uses at least the attenuation experienced by the most recent alarm signal on its way from the transmitter to the receiver. Optionally, the evaluation unit uses an averaging of the attenuations of a fixed number of alarm signals or of alarm signals in a sliding time window. In order to select an alarm intensity, the evaluation unit preferably applies a computer-executable assignment rule. This assignment rule assigns an alarm intensity to each attenuation from a range of possible attenuations.

This assignment rule and thus preferably the range of possible attenuations are specified in advance in one implementation.

In another implementation, which is described below, the evaluation unit calculates this assignment rule at runtime, during use of the arrangement, and thus preferably this range of possible attenuations. Preferably, it calculates this range in response to the event that the receiver has received an alarm signal for the first time, from the transmitter worn by the person to be found on his/her body. The evaluation unit thus generates an assignment rule that depends on the current circumstances and environmental conditions, in particular on a current shielding between the transmitter and the receiver. It is not necessary to specify the assignment rule in advance. This example embodiment is described in more detail below.

According to the example embodiment, the arrangement is configured as follows, and an example embodiment of the method comprises the following steps:
a use, in which the arrangement is used, is started.
a first person wears the transmitter and preferably the rescue signal generator on his/her body, a second person wears the alarm unit and preferably the receiver on his/her body.
typically, the rescue signal generator does not generate a rescue signal at the beginning of the operation, and the transmitter does not send out a sequence of alarm signals.

As soon as the rescue signal generator generates and sends out the rescue signal, the first person becomes the person to be found, and the second person becomes the searching person. The receiver receives an alarm signal for the first time, for example after an optional further alarm worn by the person to be searched unit on his/her body has issued a visual and/or an acoustic alarm and the searching person has moved close to the person to be found. In the following, the first alarm signal received is referred to as “the first alarm signal”, even if it is not necessarily the first alarm signal in the sequence transmitted by the transmitter.

The event that the receiver receives the first alarm signal triggers the following steps:
the receiver measures the initial received signal strength, which is the signal intensity with which the first alarm signal reaches the receiver.
the evaluation unit determines an initial attenuation, which is the attenuation that acts on the first alarm signal on its way from the transmitter to the receiver. For this purpose, the evaluation unit uses the measured initial received signal strength and optionally an initial transmitted signal strength, the first alarm signal including information about the initial transmitted signal strength used.
The evaluation unit generates the assignment rule mentioned above. For this purpose, the evaluation unit uses the determined initial attenuation and also the prespecified number z of possible alarm intensities and optionally a prespecified reference attenuation under prespecified environmental conditions.
Optionally, the evaluation unit calculates a range of possible attenuations in order to generate the assignment rule. The assignment rule assigns an alarm intensity to each attenuation in this range.

As a rule, further alarm signals reach the receiver during this use. The event that the receiver receives a further alarm signal from the transmitted sequence during this operation triggers the following steps:
The evaluation unit determines the attenuation that the further alarm signal experiences on its way from the transmitter to the receiver and optionally performs an averaging over several attenuations of further alarm signals.
If the determined attenuation of the further alarm signal lies within the range of possible attenuations, the evaluation unit selects one of the z possible alarm intensities. For this selection, the evaluation unit applies the generated assignment rule to the determined attenuation of the further alarm signal.
The controller causes an alarm to be issued with the selected alarm intensity. If an alarm with a different alarm intensity is already being issued, the controller effects that the selected alarm intensity is used to issue the alarm.
If the determined attenuation is outside the range of possible attenuations, in particular if it is greater, the controller preferably effects that no alarm is issued or that the issuance of an alarm is stopped.

Preferably, the evaluation unit causes the issuance of an alarm to be stopped if no alarm signal reaches the receiver within a period of a predetermined duration.

A person wearing the alarm unit on his/her body can distinguish between the z different alarm intensities. In an example embodiment, the z possible alarm intensities are specified as follows: z1 of the z possible alarm intensities are weaker alarm intensities. The remaining z−z1 possible alarm intensities are stronger alarm intensities. Here z1>=1 is a prespecified number, and following applies: z1<z and in particular z1=1 or z1=2. The person perceives an alarm as weaker if this alarm is issued with one of the z1 weaker alarm intensities, compared to an output with one of the z−z1 stronger alarm intensities.

In one implementation, one of the z specified alarm intensities is a minimum alarm intensity. The person perceives this minimum alarm intensity as weaker than the or any other specified alarm intensity. For example, the volume, amplitude and/or frequency of an acoustically or haptically issued alarm is lower at the minimum alarm intensity or, in the case of pulsed alarms, the pulse duration is lower than at any other alarm intensity.

Preferably, the evaluation unit generates the assignment rule as follows: the assignment rule assigns one of the z1 weaker alarm intensities to the initial attenuation, in particular the minimum alarm intensity. This example embodiment has the following effect: as soon as the receiver receives the first alarm signal, i.e. receives an alarm signal for the first time, the alarm unit issues the alarm with a weaker, in particular the minimum, alarm intensity. This example embodiment has in particular the following effect: the searching person with the alarm unit clearly notices the event that he/she is approaching the person to be found.

In a development of this example embodiment, an order is specified among all z possible alarm intensities. The z1 weaker alarm intensities just mentioned are the z1 first alarm intensities in this order. In particular, the minimum alarm intensity just mentioned is the first alarm intensity in this order. Each further alarm intensity is perceived as stronger than the alarm intensity that immediately precedes it in this order. For example, each alarm intensity has a greater volume, amplitude and/or frequency or a longer pulse duration than the previous alarm intensity. The assignment rule is configured as follows: as the attenuation decreases, the alarm intensity assigned by the assignment rule is greater or at least remains the same according to the specified order. To put it simply: the smaller the attenuation, the greater the alarm intensity.

Preferably, the assignment rule assigns an alarm intensity to each interval from the range of possible attenuations.

In one implementation, the above-mentioned assignment rule assigns the second weakest alarm intensity to the initial attenuation. This implementation has in particular the following further effect: if the searching person moves away from the person to be found after receiving the first alarm signal, the alarm is issued with the minimum alarm intensity and will therefore be weaker than the alarm issued initially.

As a rule, the alarm signal is attenuated less the closer the searching person with the alarm unit comes to the person to be found with the transmitter. For this reason, the searching person becomes more and more aware of the alarm the closer the searching person gets to the person to be found. In many cases, the searching person can therefore use the different alarm intensities to determine whether he/she is getting closer to or further away from the person to be found, or whether the distance remains roughly the same.

The assignment rule just mentioned assigns each attenuation from a range of possible attenuations to one of the z possible alarm intensities. Preferably, this range of possible attenuations has an upper attenuation threshold. Preferably, the evaluation unit is configured as follows: if the attenuation experienced by an alarm signal on the way from the transmitter to the receiver is greater than the upper attenuation threshold, the evaluation unit causes no alarm to be issued or the issuance of an alarm to be stopped.

In one example embodiment, this upper attenuation threshold is fixedly prespecified. In an example embodiment, however, the evaluation unit is configured to generate the upper attenuation threshold during an operation, specifically depending on the determined initial attenuation and the prespecified number z of possible alarm intensities.

According to the present disclosure, the alarm unit is configured to issue an alarm in an acoustically and/or haptically perceptible manner. In one example embodiment, the alarm unit comprises a vibration motor, optionally with a desired imbalance. The controller can control the vibration motor. The controlled vibration motor generates vibrations, and the vibrations act as a haptic alarm and can be perceived by a person on his her body and/or with his/her hearing.

Depending on a corresponding control by the controller, this vibration motor rotates and/or oscillates and vibrates due to the imbalance or oscillations. The control and thus the vibrations depend on the selected alarm intensity.

In one implementation, the vibration motor vibrates constantly, i.e. without a break, the strength of the vibrations remaining the same as long as the alarm intensity does not change. In another implementation, the vibration motor vibrates in pulsed fashion at at least one alarm intensity.

In one implementation, the vibration motor is configured to vibrate with at least two different amplitudes and/or with at least two different frequencies. The amplitude and/or frequency with which the vibration motor causes these vibrations depends on the control and thus on the selected alarm intensity. In pulsed operation, the duration of the pulses and/or the duration of the breaks between two pulses, i.e. the pulse frequency, can additionally or instead depend on the selected alarm intensity. The pulse duration and/or the pulse frequency in turn depend on the control.

A person wearing the alarm unit on his/her body can perceive the vibrations of the vibration motor haptically and/or acoustically. In many cases, this also applies if there is a high noise level in that person's environment and/or if the person is talking to another person. In particular in these two cases, it is possible that an acoustic alarm originating from a remote alarm device may not be perceived. The person is also able to distinguish between the vibrations of the vibration motor due to the z different alarm intensities. In particular, the person is able to perceive the different vibrations on the skin of his face and/or hear the varying sound produced by the vibration motor.

An example embodiment of how this vibration motor is arranged relative to the body of the person with the alarm unit, i.e. the searching person, is described in the following. According to this example embodiment, the arrangement according to the present disclosure belongs to a system, which system further comprises a protective device. The protective device is configured to protect a person's head and preferably includes a protective helmet. The protective helmet includes a domed hard helmet shell and a mask. The mask is located in front of the face of the searching person and is preferably held on the head by a strap.

The protective device comprises an inner surface, i.e. a surface facing the head of the wearer of the protective device. An interior space occurs between the head, preferably the face of the wearer on the one hand and the inner surface of the protective device on the other. The alarm unit or at least one alarm device of this alarm unit is arranged in this interior space. In one implementation, the protective device includes a breathing mask with a frame. The alarm device is located on this frame of the breathing mask.

This example embodiment further reduces the risk that the searching person will not notice an alarm. In addition, the protective device protects the wearer's head and, to a certain extent, the alarm unit, from external mechanical, chemical and thermal influences.

The two example embodiments just described can be combined with each other. According to this combination, the alarm unit includes a controllable vibration motor. The amplitude and/or frequency at which the vibration motor vibrates, and optionally the pulse duration in pulsed operation, is determined by the selected alarm intensity. This vibration motor is located in the above-mentioned intermediate space between the head of a wearer of the protective device and the inner surface of the protective device facing the wearer. The wearer of the protective device perceives the vibrations of the vibration motor haptically on his head, especially on his face, and/or acoustically.

According to the present disclosure, the transmitter is configured to generate and transmit a sequence of alarm signals. The receiver is configured to receive an alarm signal. The following example embodiment takes into account the possibility that the same receiver receives alarm signals from at least two different transmitters in a temporally overlapping manner. According to this example embodiment, the or each transmitter of the arrangement is configured to generate and transmit the alarm signals in such a way that each alarm signal additionally comprises an identifier of this transmitter. This enables the receiver to automatically distinguish between alarm signals from different transmitters.

In one example embodiment, the controller of the arrangement is configured as follows: The controller controls the alarm unit in response to the event that the associated receiver receives an alarm signal for the first time. Based on the identifier, the receiver “knows” from which transmitter this alarm signal is coming. The controller subsequently only uses alarm signals from the same transmitter to control the alarm unit. This situation preferably remains until the alarm detector is no longer sending out a rescue signal.

### BRIEF DESCRIPTION OF THE DRAWINGS

The present disclosure will be described below on the basis of an exemplary embodiment. In the drawings, FIG. 1 is a schematic side view of a firefighter to be rescued and two searching firefighters, as well as four alarm zones;

FIG. 2 is a schematic plan view of a floor plan of a floor, the route of a searching firefighter through this floor, and the four alarm zones of FIG. 1;

FIG. 3 shows a relationship by way of example between attenuation and alarm intensity;

FIG. 4 shows a mask worn by the searching firefighter in front of his/her face, which is part of his/her personal protective equipment;

FIG. 5 shows an output unit of the mask with a display element;

FIG. 6 shows the output unit of FIG. 5 with the housing partially removed and a vibration motor;

FIG. 7 shows a temporal course, by way of example, of the intensity of the received alarm signal (RSSI) for the path in FIG. 2;

FIG. 8 shows a temporal course, by way of example, of the attenuation of the alarm signal on its way from the transmitter to the receiver; and

FIG. 9 shows a temporal course, by way of example, of the RSSI of an alarm signal.

### DETAILED DESCRIPTION

FIG. 1 is a schematic side view of an application by way of example of the present disclosure. In the exemplary embodiment, the present disclosure is used so that a searching person sP can find a person rP to be rescued. The two persons rP, sP are on the same floor of a building and are, for example, firefighters. It is also possible that the person to be rescued and the searching person are two rescue workers searching for people in danger in a mine or a collapsed building.

The firefighter rP to be rescued is wearing a protective helmet 20 and has suffered an accident or a fainting spell or has been buried, is therefore lying on the ground, is not moving and must be found and rescued. The searching firefighter sP is wearing a protective helmet 21 and is searching for the firefighter rP lying on the ground.

The search is often made more difficult by the fact that visibility on the floor is very limited, for example due to darkness or heavy smoke. It is also possible that the firefighter rP to be rescued is buried or is underneath an object. There may be an object, such as a wall, between the searching firefighter sP and the firefighter rP to be rescued.

The firefighter rP to be rescued wears a device 25 with an alarm detector on his/her protective equipment and a signal-processing rescue signal generator 10. The alarm detector is configured to automatically detect at least one unwanted event. The occurrence of this unwanted event means that the firefighter rP must be rescued. In the exemplary embodiment, the alarm detector comprises a dead man sensor 3 with an acceleration sensor. The acceleration sensor is configured to measure the three linear accelerations and the three angular accelerations in an imaginary Cartesian coordinate system. The dead man sensor 3 detects the event that the firefighter rP moves less than a specified tolerance in a specified period of time. For example, the firefighter rP lies motionless on the ground. If the dead man sensor 3 has detected that a possible unwanted event has actually occurred, the rescue signal generator 10 generates a corresponding signal. This signal is called the rescue signal Rs.

In addition, the device 25, which the firefighter rP to be rescued wears on his/her protective equipment, comprises
a transmitter 1,
a signal-processing controller (control unit) 4,
its own voltage supply unit 11 and
a charge state sensor 12.

The voltage supply unit 11 supplies the remaining electrical consumers of the device 25 with electrical energy. The charge state sensor 12 measures the current charge state of the voltage supply unit 11. The rescue signal Rs of the rescue signal generator 10, according to which an unwanted event has been detected, is transmitted to the controller 4. In response to the receipt of the rescue signal Rs, in the exemplary embodiment the controller 4 triggers the following two steps:
A loudspeaker, a horn, or a siren 8 attached to the protective equipment of the firefighter rP to be rescued issues an acoustic alarm.
The transmitter 1 transmits a sequence Sig of alarm signals Sig(1), Sig(2), . . . , in one implementation with a fixed transmission frequency.

In one implementation, the acoustic alarm is issued and the sequence Sig of alarm signals Sig(1), Sig(2), . . . is sent until an operating element on the protective equipment of the firefighter rP to be rescued has been actuated. As a rule, the searching firefighter sP actuates this operating element and thereby confirms that he/she has found the firefighter rP to be rescued. In another implementation, the acoustic alarm is issued, and the sequence Sig is transmitted as long as the rescue signal generator 10 generates the rescue signal Rs and the controller 4 receives the rescue signal Rs.

The searching firefighter sP can usually perceive the acoustic alarm emitted by the loudspeaker or the horn or the siren 8 with his hearing and without any aids. However, although the acoustic alarm often leads the searching firefighter sP into the vicinity of the firefighter rP to be rescued, in cases of heavy smoke development or poor visibility or if the firefighter rP to be rescued is buried, the acoustic alarm alone is often not sufficient to find the firefighter rP to be rescued. For this reason, the transmitter 1 also sends the sequence Sig.

The transmitter 1 sends this sequence Sig via broadcasting, i.e. without specifying a receiver in an alarm signal. In the exemplary embodiment, the transmitter 1 uses the Bluetooth Low Energy (BLE) transmission protocol. According to the current standard, the BLE transmission protocol uses a maximum transmission power of 10 mW and therefore consumes less electrical energy than other possible transmission protocols. While using this BLE transmission protocol, in many cases a receiver that is no more than 10 m away from the transmitter 1 can receive the alarm signals even if there is a certain degree of shielding.

It is possible that different receivers receive the same alarm signal Sig. Conversely, it is possible that the same receiver receives two different alarm signals from different transmitters.

In the exemplary embodiment, each alarm signal Sig(i) comprises three pieces of information:
an identification number which uniquely identifies the transmitter 1 and thus the firefighter rP to be rescued (16 bits),
the transmission signal intensity P0(i) with which this alarm signal Sig(i) was sent (8 bits) and
that the alarm detector 3 has detected an unwanted event and an alarm has been triggered as a result (8 bits), optionally an identification of this event or alarm.

As the transmitter 1 uses the BLE transmission protocol, the alarm signals Sig(1), Sig(2), . . . are transmitted at different frequencies (frequency hopping). In the exemplary embodiment, the alarm signals Sig(1), Sig(2), . . . are also transmitted with different transmission signal intensities P0(1), P0(2), . . . . Before the transmitter 1 transmits an alarm signal Sig(i), the transmitter 1 automatically specifies the transmitted signal strength P0(i) of this alarm signal Sig(i) (i=1, 2, . . . ), for example using a random generator. Alternatively, a temporal progression of the transmitted signal strength P0(i) is prespecified.

Each transmission signal intensity P0(i) is less than a maximum transmission signal intensity or at most equal to the maximum transmission signal intensity. In one example embodiment, the maximum transmission signal intensity is prespecified and remains constant. In another example embodiment, the transmitter 1 is configured to reduce the maximum transmission signal intensity depending on the current charge state of the voltage supply unit 11, the charge state sensor 12 measuring this charge state. In one implementation, the transmitter 1 continuously reduces the maximum transmission signal intensity depending on the decreasing charge state of the voltage supply unit 11. The transmitter 1 increases the maximum transmission signal intensity again if the voltage supply unit 11 has been charged. In another implementation, the transmitter 1 uses a predetermined maximum transmission signal intensity as long as the charge state is greater than a lower charge state threshold, and the transmitter 1 only reduces the maximum transmission signal intensity if the charge state is lower. All these implementations extend the possible operating time of the transmitter 1, compared to an implementation in which the same maximum transmission signal intensity is used throughout.

The searching firefighter sP wears on his protective equipment
a receiver 2,
a further transmitter 1.1 and
a controller 9 having a signal-processing evaluation unit 5.

The evaluation unit 5 evaluates received signals. If the receiver 2 has received an alarm signal Sig(i) and this alarm signal Sig(i) identifies a transmitter on the body of a firefighter rP to be rescued, the controller 9 causes the following two steps to be carried out:
an alarm unit 6 on the protective equipment of the searching firefighter sP issues an alarm. If the receiver 2 has not received such an alarm signal, the alarm unit 6 will not issue an alarm.
the further transmitter 1.1 issues a further alarm signal. The transmission signal intensity with which the further transmitter 1.1 transmits the further alarm signal is, in the exemplary embodiment, equal to the transmission signal intensity P0(i), via which information is contained in the received alarm signal Sig(i).

In the exemplary embodiment, the alarm unit 6 vibrates and thereby issues a haptic alarm. Instead of or in addition to a haptic alarm, the alarm unit 6 can also issue an acoustic alarm. It is also possible that the searching firefighter sP perceives the vibrations both haptically and acoustically.

In one example embodiment, the event that the receiver 2 has received an alarm signal Sig(i) causes the alarm unit 6 to output the haptic and/or acoustic alarm in any case. In another example embodiment, the searching firefighter sP uses a corresponding operating element to determine whether he/she currently wishes the alarm unit 6 to issue an alarm or whether he/she currently does not wish this. A possible situation in which the alarm unit 6 should not issue an alarm is the following: while the searching firefighter sP is busy rescuing another person, he/she cannot usually search for the firefighter rP to be rescued.

Preferably, a sequence with z different alarm intensities As.1, . . . , As.z is prespecified. In the case of a haptic alarm, the z alarm intensities As.1, . . . , As.z differ by the frequency and/or amplitude of the vibrations. Optionally, the vibrations are emitted in pulsed form, and the z alarm intensities As.1, . . . , As.z differ additionally or instead by the pulse duration and/or by the duration between two pulses. In the exemplary embodiment, z=4. An alarm intensity As.(x+1) is perceived by a person as a stronger alarm than the immediately preceding alarm intensity As.x (x=1, . . . , z−1). The first alarm intensity As.1 is thus perceived as the weakest alarm, the last alarm intensity As.z as the strongest alarm.

Put simply, the alarm becomes stronger the closer the searching firefighter sP comes to the firefighter rP to be rescued. This principle is known, for example, from a parking aid that helps a driver to reverse into a parking space and that issues an alarm that becomes louder the closer the car gets to an obstacle.

A region around the transmitter 1 in which the alarm unit issues the alarm with a particular alarm intensity As.x is called the alarm zone Az.x. The alarm unit 6 therefore issues the alarm with the alarm intensity As.x if the receiver 2 and thus the searching firefighter sP is located in an alarm zone Az.x around the firefighter rP to be rescued (x=1, 2, . . . ).

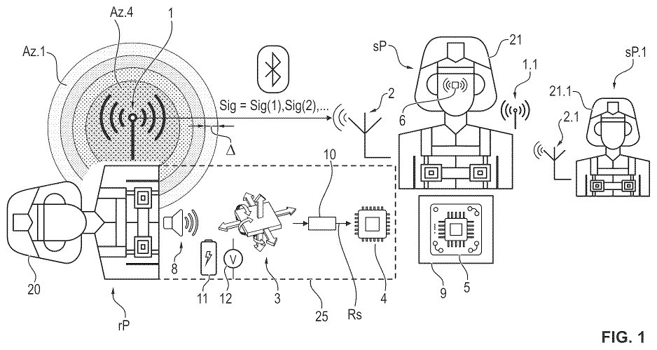

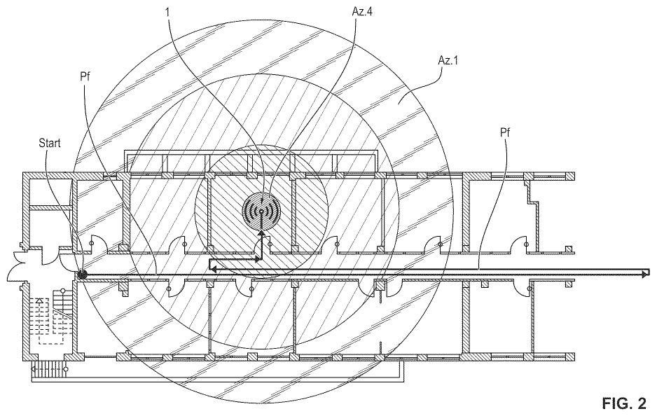

This alarm zone Az.x is unknown. The term alarm zone is used in this description for illustrative purposes. By way of example, the z different alarm zones Az.1, . . . , Az.z and the respective alarm intensities As. 1, . . . , As.z are indicated in FIG. 1 and FIG. 2 by concentric circles around the transmitter 1. These concentric circles occur under an idealized condition where the attenuation experienced by an alarm signal Sig(i) on its way from the transmitter 1 to the receiver 2 depends only on the distance between the transmitter 1 and the receiver 2. This idealized condition is not usually encountered in practice.

In the example in FIG. 1, the searching firefighter sP is still outside the largest circle Az.1, namely outside the circle Az.1 for the weakest alarm intensity As.1. For this reason, his alarm unit 6 does not issue an alarm in this situation. FIG. 2 is a plan view of a floor plan of a floor in which the firefighter rP to be rescued is located and in which the searching firefighter sP is searching for the firefighter rP to be rescued. The searching firefighter sP moves along a path Pf through this floor until he/she finds the transmitter 1 and thus the firefighter rP to be rescued.

An example embodiment of the alarm unit 6 is described below. As already mentioned, this alarm unit 6 is attached to the protective equipment of the searching firefighter sP.

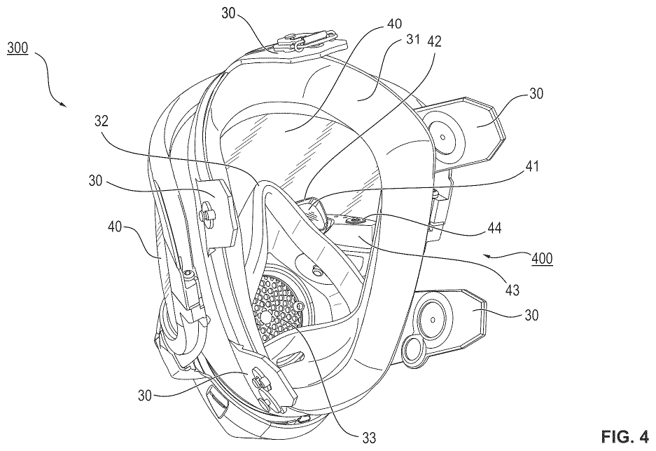

The two firefighters rP, sP are each wearing protective equipment with a protective helmet 20, 21. The protective helmet includes a domed helmet shell (not shown), a strap (also not shown) and a mask 300. The mask 300 is part of the protective equipment of the searching firefighter sP and is located in front of his/her face. FIG. 4 shows the mask 300, by way of example and viewed diagonally from behind. In a first implementation, the strap can be detachably attached to the mask 300 by means of several connecting elements 30, and the strap holds the mask 300 in front of the face of the searching firefighter sP. In a second implementation, the mask 300 can be releasably attached to the inside of the helmet shell by means of at least one connecting element 30. These two implementations can be combined with each other.

The mask 300 comprises a visor 40 with a frame and a sealing element 31. The frame of the visor 40 is attached to the sealing element 31. The sealing element 31 surrounds the face of a wearer of the protective helmet in a fluid-tight manner. A V-shaped sealing element 32 rests on top of the wearer's nose and separates the nose and mouth area from an eye area. A cylindrical valve element 33 is arranged in front of the wearer's mouth and allows the wearer to exhale through the valve element 33 but prevents the wearer from inhaling ambient air. The ambient air may be contaminated with harmful particles and smoke during an operation. During an operation, the wearer breathes air exclusively from a breathing air cylinder (not shown).

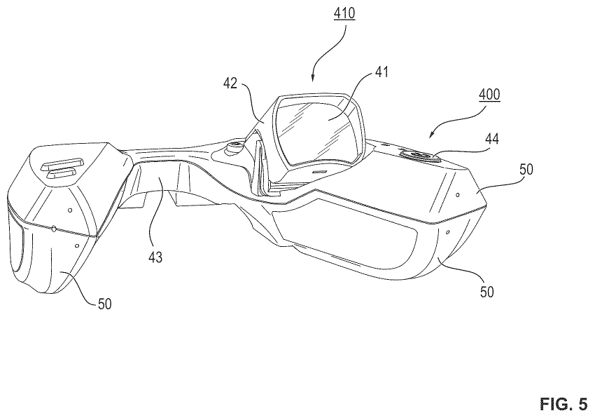

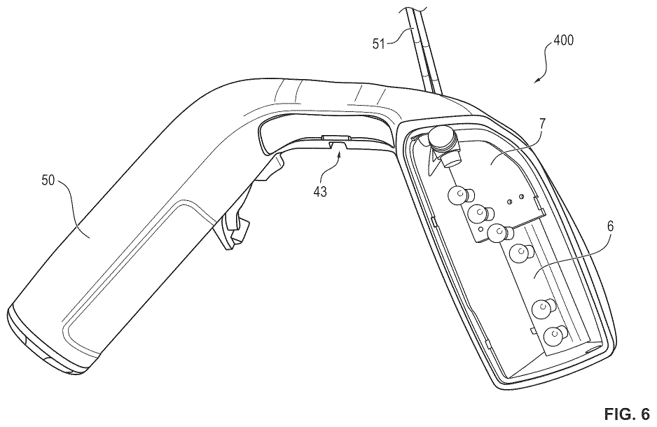

An output unit 400 is fastened, preferably detachably fastened, in front of the wearer's eyes and between the wearer's face and the visor 40. The output unit 400 is therefore located in the space enclosed by the mask 300 with the visor 40 and the wearer's face. FIG. 5 shows the output unit 400 approximately from the viewing direction with which a wearer looks at the output unit 400, FIG. 6 obliquely from above.

The output unit 400 comprises a display element 410 and an approximately U-shaped base body 43 with a multi-part base body housing 50. The display element 410 comprises an approximately rectangular display surface 41 and a display housing 42. The dimensions of the base body 43 are adapted to the typical dimensions of an adult face. While in use, the two legs of the base body 43 are arranged approximately horizontally. The display housing 42 is mounted on top of the base body 43 and surrounds the display surface 41. A button 44 serving as the operating element is embedded in the base body 43, with the aid of which the output unit 400 can be activated and deactivated. The display element 410 only obstructs the wearer's view through the visor 40 to a relatively small extent.

FIG. 6 shows the output unit 400 from above, the display surface 41, the display housing 42, and the button 44 not being shown. Inside the housing 50 there is a vibration motor 6 and a circuit board 7. The vibration motor 6 belongs to the alarm unit of the example embodiment, the circuit board 7 to the controller 9. A circuit which controls the vibration motor 6 is printed on the circuit board 7. Depending on the control, the vibration motor 6 does not vibrate or vibrates with one of the z possible alarm intensities As.1, . . . , As.z. For example, the vibration motor 6 oscillates or has an intentional imbalance and rotates and vibrates due to the imbalance. In addition, an electrical contact 51 for the circuit board 7 and the vibration motor 6 is shown. The searching firefighter sP perceives the vibrations generated by the vibration motor 6, as well as the z different alarm intensities As.1, . . . , As.z, on his/her face and/or with his/her hearing.

As explained above, each alarm signal Sig(i) contains information about the transmitter 1, in particular a unique identifier. The receiver 2 can therefore distinguish between alarm signals and other signals from different transmitters. In the following description, all alarm signals Sig(1), Sig(2), . . . originate from the same transmitter 1 on the protective equipment of the firefighter rP to be rescued.

The evaluation unit 5 of the searching firefighter sP determines for each alarm signal Sig(i) received by the receiver 2, the received signal strength P(i) with which this alarm signal Sig(i) reaches the evaluation unit 5. As a rule, the alarm signal Sig(i) is attenuated on the way from the transmitter 1 to the receiver 2 and is never amplified. This attenuation results in particular from the fact that the alarm signal Sig(i) is reflected and/or shielded.

The alarm signal Sig(i) therefore experiences an attenuation d (i) on the way from the transmitter 1 to the receiver 2. In the following, different implementations of how this attenuation d (i) is calculated are described.

In one implementation, the transmission power or receiving power P is used as the signal intensity, e.g. in [mW], and the attenuation d (i) is calculated according to the formula:

$$d ( i ) = P 0 ( i ) - P ( i ) \qquad ( 1 )$$

or as normalized attenuation:

$$d ( i ) = [ P 0 ( i ) - P ( i ) ] / P 0 ( i ) \qquad ( 2 )$$

or as attenuation with reference to a reference attenuation:

$$d ( i ) = [ P 0 ( i ) - P ( i ) ] / [ P {0}_{ref} - {P}_{ref} ] . \qquad ( 3 )$$

Here, P0(i) is the transmission signal intensity with which the transmitter 1 has sent the alarm signal Sig(i). Information about this transmission signal intensity P0(i) is contained in alarm signal Sig(i). P(i) is the determined received signal strength with which the alarm signal Sig(i) reaches the receiver 2. As a rule, 0<P(i)<P0(i).

In formula (3), P0_{ref} is a reference transmission signal intensity of the transmitter 1, and Pref is a reference received signal strength which the receiver 2 has determined at the reference transmission signal intensity P0_{ref}. The reference transmission signal intensity P0_{ref} is specified in advance, and the reference received signal strength Pref is determined in advance under predetermined reference conditions. The reference conditions include, for example, that there is a distance of 1 m between the transmitter 1 and the receiver 2, and that an alarm signal Sig(i) is neither reflected nor shielded on the way from the transmitter 1 to the receiver 2.

An example implementation described below takes into account that many transmitters and receivers available today output a signal intensity as RSSI (Received Signal Strength Indicator), preferably as a power level Lp(i) in [dB] according to the formula:

$$Lp ( i ) = 10 lg P ( i ) and Lp 0 ( i ) = 10 lg P 0 ( i ) . \qquad ( 4 )$$

Lg is the logarithm to base 10. Lp(i)<=Lp0(i).

The attenuation d (i) is calculated according to the formula:

$$d ( i ) = Lp 0 ( i ) - Lp ( i ) ; \qquad ( 5 )$$

$$or$$

$$d ( i ) = [ Lp 0 ( i ) - Lp ( i ) ] / [ Lp {0}_{ref} - {Lp}_{ref} ] . \qquad ( 6 )$$

Lp0_{ref} is a reference transmission power level, Lp_{ref} is a reference received power level. These two power levels were again determined under the reference conditions described above.

The attenuation d (i) of an alarm signal Sig(i) can depend on the frequency and the transmission signal intensity P0(i) with which the transmitter 1 transmits the alarm signal Sig(i). The frequency is varied according to the transmission protocol BLE, the transmission signal intensity P0(i) according to the example embodiment. The influences of the frequency and the transmission signal intensity P0(i) on the attenuation are mathematically eliminated to a certain extent in the exemplary embodiment. For this purpose, the length T of a sliding time window is specified, specifically preferably in such a way that n+1 consecutive alarm signals Sig(i−n), . . . , Sig(i) are transmitted in the sliding time window. It is possible that only some of these n+1 alarm signals reach the receiver 2. The length of this sliding time window remains constant in one example embodiment and is varied over time in another example embodiment. A suitable averaging is performed over the n+1 attenuations d(i−n), . . . , d(i) experienced by these n+1 alarm signals Sig(i−n), . . . , Sig(i). The averaging is preferably carried out with the aid of the median. The median is less sensitive to outliers than is the arithmetical mean.

This averaging over n+1 attenuations yields an averaged attenuation d_{med}(i). In one example embodiment,

$${d}_{m e d} ( i ) = median [ d ( i - n ) , … , d ( i ) ] . \qquad ( 7 )$$

The following sequence is carried out as soon as the receiver 2 has received for the first time an alarm signal Sig(1) from the transmitter 1 on the protective equipment of the firefighter rP to be rescued. This first received alarm signal is designated Sig(1), even if it is not the first transmitted alarm signal. By way of example, FIG. 2 shows that the searching firefighter sP is at the position Start in that moment in which the receiver 2 on his her protective clothing receives an alarm signal Sig(1) from the transmitter 1 for the first time. The firefighter rP to be rescued and thus the transmitter 1 do not change their position in this example.

After the receiver 2 has received an alarm signal from the transmitter 1 for the first time, i.e. the alarm signal Sig(1), the controller 9 causes the haptic alarm unit (vibration motor 6) to repeatedly output an alarm, preferably with a fixed output frequency. The searching firefighter sP perceives this alarm on the skin of his/her face and/or with his/her hearing. The alarm intensity As.x with which the alarm unit 6 issues the alarm depends on the averaged attenuation d_{med}(i) in the most recent time window T(i).

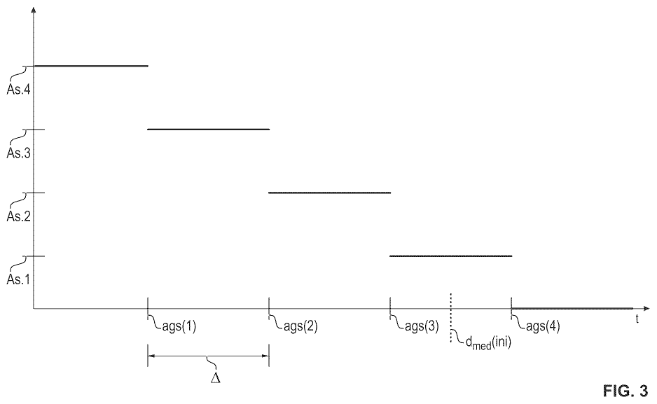

After the receiver 2 has received the first alarm signal Sig(1), the controller 9 calculates a sequence of z alarm threshold intensities ags(1)<ags(2)< . . . <ags(z). Each alarm threshold intensity ags (x) is a specific attenuation. The alarm unit 6 issues the alarm with the alarm intensity As.x if the averaged attenuation d_{med}(i) in the most recent time window T(i) is greater than or equal to ags(z−x) and less than ags(z−x−1) (x=2, . . . , z−1). If the averaged attenuation d_{med}(i) is less than ags(1), the alarm unit 6 issues the alarm with the maximum alarm intensity As.z. If the averaged attenuation d_{med}(i) is greater than ags(z), the alarm unit 6 does not issue an alarm. This is illustrated in FIG. 3 where z=4.

The following describes how the evaluation unit 5 calculates the z alarm threshold intensities ags(1)<ags(2)< . . . <ags(z).

The step that the receiver 2 has received the first n+1 alarm signals Sig(1), . . . , Sig(n+1) triggers the following steps:
the alarm unit 6 issues the alarm, specifically with the lowest possible alarm intensity As.1 or with the second lowest alarm intensity As.2.
the evaluation unit 5 calculates an averaged initial attenuation d_{med}(ini), depending on the attenuations d(1), . . . , d(n+1) of the first n+1 alarm signals Sig(1), . . . , Sig(n+1).

The initial attenuation d_{med}(ini) is preferably calculated according to the following calculation rule:

$${d}_{m e d} ( i n i ) = median [ d ( 1 ) , … , d ( n + 1 ) ] . \qquad ( 8 )$$

In the example in FIG. 2, this step is triggered as soon as the searching firefighter sP has reached the position Start.

In one implementation, the evaluation unit 5 calculates the z alarm threshold intensities such that:

$$ags ( z - 1 ) < {d}_{m e d} ( i n i ) < ags ( z ) . \qquad ( 9 )$$

The following describes an implementation of how the evaluation unit 5 calculates the z alarm threshold intensities ags(1)<ags(2)< . . . <ags(z). According to this implementation, the evaluation unit 5 calculates a zone width Δ, namely after the evaluation unit 5 has calculated the initial attenuation d_{med}(ini). This zone width Δ is the distance between two immediately consecutive alarm threshold intensities. For illustration purposes, the zone width Δ is shown in FIG. 1 and FIG. 3.

In one example embodiment, the evaluation unit 5 calculates the zone width Δ according to the following calculation rule

$$Δ = \vert {d}_{med} ( ini ) - {d}_{ref} \vert / ( z - 2 ) . \qquad ( 10 )$$

Here, |x| is the absolute value of a number x, d_{ref} is a reference attenuation under given reference conditions, and z is the predetermined number of alarm intensities and alarm zones. The reference attenuation d_{ref} is effected, for example, if a distance of 1 m occurs between the transmitter 1 and the receiver 2, and an alarm signal Sig(i) is neither reflected nor shielded on the way from the transmitter 1 to the receiver 2.

In the example embodiment, the evaluation unit 5 specifies the z alarm zones Az. 1, . . . , Az.z depending on the following information:
the initial attenuation d_{med}(ini), and
the zone width Δ.

The alarm zone Az.1 is the zone with the lowest alarm intensity As.1, the alarm zone Az.z is the zone with the highest alarm intensity As.z. In one implementation, the initial attenuation d_{med}(ini) leads to the lowest alarm intensity As.1, in another implementation to the second lowest alarm intensity As.2.

As can be seen in FIG. 3, in one implementation the evaluation unit 5 calculates the z alarm threshold intensities ags(1), . . . , ags(z) as follows:

$$ags ( z ) = {d}_{med} ( ini ) + Δ / 2 and ags ( i - 1 ) - ags ( i ) - Δ ( i = 2 , … , z ) . \qquad ( 11 )$$

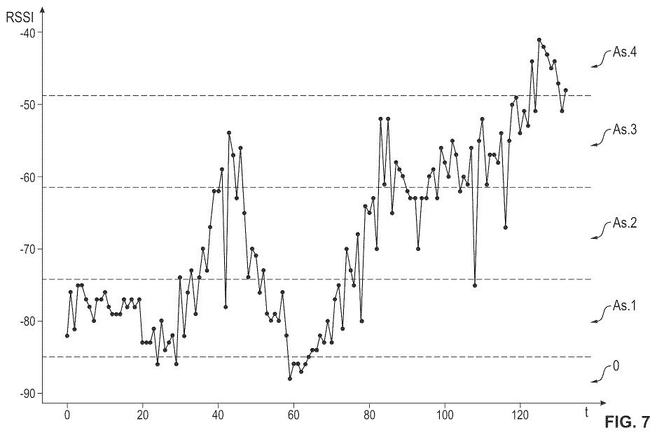

FIG. 7 shows, by way of example, the temporal course of the received signal strength with which the receiver 2 receives the sequence Sig of alarm signals that the transmitter 1 has generated and transmitted. The x-axis shows the time, the y-axis the received signal strength as RSSI. The temporal course of FIG. 7 refers to the path Pf in FIG. 2. The searching firefighter sP moves through the floor along this path Pf. In addition, FIG. 7 shows the alarm intensity As.1, . . . , As.4 resulting in each case, as well as a received signal strength at which no alarm is issued (0).

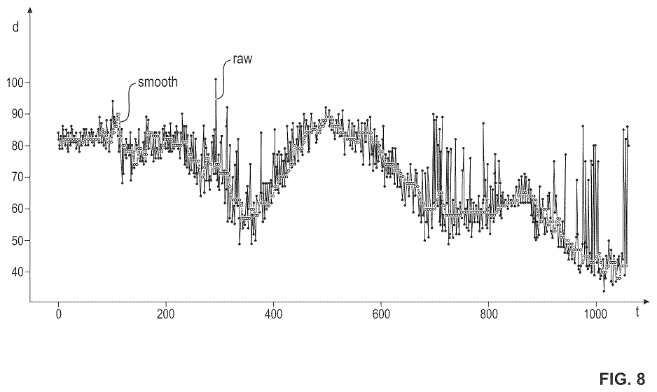

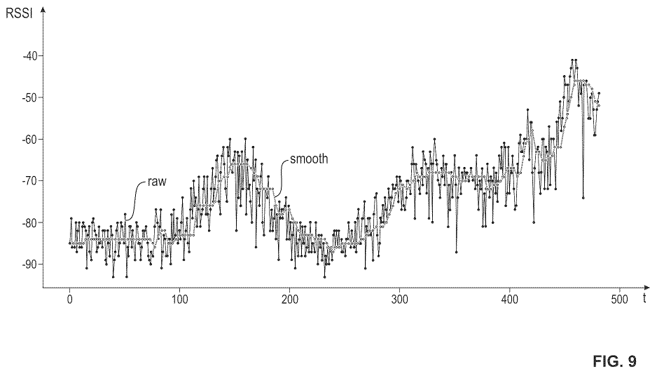

FIG. 8 and FIG. 9 illustrate, by way of example, the effect of averaging the attenuation over a sliding time window and thereby smoothing it. FIG. 8 shows the temporal course of the attenuation d, FIG. 9 the temporal course of the received signal strength (RSSI). ‘Raw’ denotes the temporal course of the respective raw values, i.e. the attenuation d (i) or the received signal strength RSSI (i) of a single alarm signal Sig(i), ‘smooth’ denotes the smoothing over the attenuations or received signal strengths of the last n+1 alarm signals Sig(i−n), . . . , Sig(i). The smoothing was performed with the aid of the median.

So far, an example embodiment with a searching firefighter sP has been described. Often, a firefighter rP to be rescued is searched for by the searching firefighter sP with the receiver 2 and by another searching firefighter who also carries a receiver with him/her. In the example in FIG. 1, a further searching firefighter sP.1 is shown. The further searching firefighter wears a protective helmet 21.1 and wears a further receiver 2.1 and, in the example embodiment, a further alarm unit (not shown). In one example embodiment, the receiver 2 belongs to a relay station being configured not only to receive alarm signals but also to transmit them. The step in which the receiver 2 receives an alarm signal Sig(i) triggers the following step: The further transmitter 1.1 sends an alarm signal Sig.1(i) via broadcasting. The following alternatives for the signal intensity with which the further transmitter 1.1 sends the alarm signal Sig.1(i) are possible:
the further transmitter 1.1 transmits the alarm signal Sig.1(i) with a prespecified and preferably temporally constant signal intensity.
the further transmitter 1.1 transmits the alarm signal Sig.1(i) with the transmission signal intensity P0(i). The alarm signal Sig(i) received by receiver 2 includes information about the transmitted signal strength P0(i).
the further transmitter 1.1 transmits the alarm signal Sig.1(i) with the determined received signal strength P(i) with which the receiver 2 received the alarm signal Sig(i).

This example embodiment allows the further firefighter sP.1 to participate in the search. As soon as the further firefighter sP.1 has come close enough to the firefighter rP to be rescued, his/her receiver 2.1 also receives an alarm signal, namely from the further transmitter 1.1. The example embodiment described above with the alarm unit 6 and the z alarm intensities As.1, . . . , As.z also apply accordingly to the further alarm unit (not shown) in or on the protective equipment of the further firefighter sP.1.

List of reference signs

| | |
|---|---|
| 1 | transmitter, attached to the protective equipment of the |
| | firefighter rP to be rescued, belongs to the device 25 |
| 1.1 | further transmitter, attached to the protective equipment of the |
| | searching firefighter sP |
| 2 | receiver, attached to the protective equipment of the searching |
| | firefighter sP |
| 2.1 | further receiver, attached to the protective equipment of the |
| | further searching firefighter sP.1 |
| 3 | alarm detector, includes a dead man sensor with an |
| | acceleration sensor, is attached to the protective equipment of |
| | the firefighter rP to be rescued |
| 4 | signal-processing controller, attached to the protective |
| | equipment of the firefighter rP to be rescued |
| 5 | evaluation unit of controller 9, calculates the z alarm threshold |
| | intensities ags(1), . . . , ags(z) |
| 6 | vibration motor in the base body housing 50, belongs to the |
| | output unit 400, acts as the alarm unit, is controlled by the |
| | controller 9 |
| 7 | circuit board for controlling the vibration motor 6 |
| 8 | loudspeaker or siren or horn, attached to the protective |
| | equipment of the firefighter rP to be rescued, issues an acoustic |
| | alarm |
| 9 | signal-processing controller of the searching firefighter sP, |
| | includes the evaluation unit 5, processes a signal received by |
| | the receiver 2, controls the vibration motor 6 |
| 10 | rescue signal generator, generates the rescue signal Rs |
| 11 | voltage supply unit for the device 25 with the transmitter 1 |
| 12 | charge state sensor, measures the current charge state of the |
| | voltage supply unit 11 |
| 20 | protective helmet worn by the firefighter rP to be rescued |
| 21 | protective helmet worn by the searching firefighter sP |
| 21.1 | protective helmet worn by the further searching firefighter sP.1 |
| 25 | device on the protective equipment of the firefighter rP to be |
| | rescued, includes the transmitter 1, the acceleration sensor 3, |
| | the controller 4, the voltage supply unit 11 and the charge state |
| | sensor 12 |
| 30 | connecting elements that detachably connect the strap to the |
| | mask 300 |
| 31 | sealing element that surrounds the wearer's face in a fluid-tight |
| | manner, carries the frame of the visor 40 in one |
| | implementation |
| 32 | V-shaped sealing element, separates the wearer's mouth and |
| | nose area from his eye area |
| 33 | cylindrical valve element in front of the wearer's mouth, allows |
| | the wearer to exhale through the valve element, but prevents |
| | the wearer from inhaling ambient air |
| 40 | visor of the mask 300, comprises a frame, attached in front of |
| | the sealing element 31 and thus in front of the face of a wearer |
| 41 | display surface of the output unit 400, embedded in the display |
| | housing 42, belongs to the display element 410 |
| 42 | display housing for the display surface 41, mounted on top of |
| | the base body 43, belongs to the display element 410 |
| 43 | U-shaped base body of the output unit 400, carries the display |
| | housing 42, includes the base body housing 50, surrounds the |
| | circuit board 7 with the circuit for the vibration motor 6 and a |
| | voltage supply unit |
| 44 | button in the base body 43 with which the output unit 400 can |
| | be activated and deactivated, serves as the operating element |
| 50 | multi-part base body housing of the base body 43, surrounds |
| | the vibration motor 6 and the circuit board 7 |
| 51 | electrical contact for the circuit board 7 and the vibration motor 6 |
| 300 | mask, located in front of the face of a wearer of the protective |
| | helmet 21, comprises the visor 40, the connecting elements |
| | 30, the sealing element 31, the V-shaped sealing element 32, |
| | the valve element 33 and the output unit 400 |
| 400 | output unit, comprises the display element 410 with the display |
| | surface 41 and the display housing 42, the base body 43 and |
| | the button 44 |
| 410 | display element, includes the display surface 41 and the |
| | display housing 42 |
| ags(1), . . . , | alarm threshold intensities, calculated by the evaluation unit 5 |
| ags(z) | depending on the initial attenuation d_{med}(ini) |
| As.x | alarm intensity, is output in the alarm zone Az.x (x = 1, . . . , z) |
| Az.x | alarm zone in which the alarm is issued with the alarm intensity |
| | As.x (x = 1, . . . , z) |
| d(i) | attenuation experienced by the alarm signal Sig(i) on its way |
| | from the transmitter 1 to the receiver 2 |
| d_{med}(i) | averaged attenuation, is formed by averaging the attenuations |
| | d(i − n), . . . , d(i) of the n + 1 most recent alarm signals Sig(i − n), . . . , |
| | Sig(i), for example by median |
| d_{med}(ini) | initial attenuation, is calculated as soon as the receiver 2 has |
| | received the first n + 1 alarm signals Sig(1), . . . , Sig(n + 1) |
| d_{ref} | prespecified reference attenuation |
| Δ | zone width, distance between two immediately consecutive |
| | alarm threshold intensities ags(i), ags(i + 1) |
| Lp0(i) | transmission power level of the alarm signal Sig(i) |
| Lp(i) | received power level of the alarm signal Sig(i) |
| Lp0_{ref} | reference transmission power level |
| Lp_{ref} | reference received power level |
| n + 1 | number of attenuations to be averaged |
| P0(i) | transmission signal intensity with which the transmitter 1 |
| | transmits the alarm signal Sig(i) |
| P0_{ref} | reference transmission signal intensity of the transmitter 1 |
| P(i) | received signal strength with which the alarm signal Sig(i) |
| | reaches the receiver 2 |
| P_{ref} | reference received signal strength which the receiver 2 has |
| | determined at the reference transmission signal intensity P0_{ref} |
| Pf | path on which the searching firefighter sP moves through the |
| | floor |
| rP | firefighter to be rescued, carries the transmitter 1, the alarm |
| | detector 3 and the controller 4 |
| Rs | rescue signal generated by the rescue signal generator 10 |
| RSSI | Received Signal Strength Indicator |
| Sig | sequence of alarm signals Sig(1), Sig(2), . . . , sent by the |
| | transmitter 1 |
| Sig(i) | alarm signal of the sequence Sig, transmitted with the |
| | transmission signal intensity P0(i) (i = 1, 2, . . . ) |
| Sig.1(i) | alarm signal sent by the further transmitter 1.1 as a reaction on |
| | receiving Sig(i) |
| sP | searching firefighter, searches for the firefighter rP to be |
| | rescued, wears a protective helmet with the mask 300 as well |
| | as the receiver 2, the further transmitter 1.1 and the controller |
| | 9 with the evaluation unit 5 |
| sP.1 | further searching firefighter, wears the receiver 2.1 |
| Start | position of the searching firefighter sP at the time at which the |
| | receiver 2 receives the first alarm signal Sig(1) |
| T(i) | time window |
| z | number of different possible alarm intensities, as well as the |
| | number of alarm zones and the number of alarm threshold |
| | intensities |
| z1 | number of different possible weaker alarm intensities |

1-20. (canceled)

21. An arrangement comprising:
a rescue signal generator;
a transmitter;
a receiver;
an alarm unit;
a signal-processing evaluation unit; and
a signal-processing controller,
wherein the transmitter:
is assigned to a first person; and
is designed to be worn by the first person on his/her body,
wherein the rescue signal generator is configured:
to generate a rescue signal; and
to cause the rescue signal to be transmitted to the transmitter, wherein the transmitter is configured to:
generate, in response to receiving the rescue signal, a sequence of alarm signals; and
transmit the sequence of alarm signals,
wherein the receiver is configured to:
receive an alarm signal of the sequence of alarm signals; and
measure a received signal strength as a signal strength with which the alarm signal reaches the receiver,
wherein the alarm unit is configured to:
be worn by a second person on his/her body; and
issue an alarm, wherein the alarm comprises at least one of an acoustic alarm or a haptic alarm in such a way that the second person, carrying the alarm unit on his/her body, perceives the alarm,
wherein the alarm unit is further configured to:
be controlled; and
issue the alarm, based on the control, in one of two or more given possible alarm intensities,
wherein the controller is configured to control the alarm unit,
wherein the evaluation unit is configured to:
determine, based on the measured received signal strength of the received alarm signal, an attenuation acting on the alarm signal on the path from the transmitter to the receiver; and
select, based on the determined attenuation of the alarm signal, one of the two or more given possible alarm intensities, and
wherein the arrangement is configured such that, based on the receiver receiving the alarm signal, the steps are performed that:
the receiver measures the received signal strength of the alarm signal;
the evaluation unit determines, based on the measured received signal strength, the attenuation acting on the alarm signal and selects, based on the determined attenuation, the one of the two or more given possible alarm intensities; and
the controller controls the alarm unit in such a way that the alarm unit issues, in response to the control, the alarm with the selected alarm intensity.

22. The arrangement of claim 21, wherein:
the transmitter is further configured to generate and transmit each alarm signal of the sequence of alarm signals in such a way that:
each given alarm signal comprises information about a transmission signal strength with which the transmitter transmits the generated alarm signal, and
wherein the evaluation unit is further configured to determine the attenuation acting on the alarm signal additionally based on the transmission signal strength about which the received alarm signal contains information.

23. The arrangement of claim 22, wherein:
the transmitter is further configured to specify for each alarm signal of the sequence of alarm signals a respective transmission signal strength in such a way that:
the sequence of alarm signals has a total of at least two different transmission signal strengths.

24. The arrangement of claim 22, wherein:
the arrangement further comprises:
a voltage supply unit; and
a charge state sensor,
wherein the voltage supply unit is configured to supply the transmitter with electrical energy,
wherein the charge state sensor is configured to measure a current charge state of the voltage supply unit, and
wherein the transmitter is further configured to:
specify, at least once and based on the measured charge state, a maximum transmission signal strength such that the lower the charge state is, the lower is the specified maximum transmission signal; and
transmit each given alarm signal in such a way that the transmission signal strength of the given alarm signal is at most equal to the specified maximum transmission signal strength.

25. The arrangement of claim 21, wherein:
the arrangement further comprises:
a further transmitter; and
a further receiver,
wherein the further transmitter is configured to, in response to the receiver receiving the alarm signal, transmit a further alarm signal,
wherein the further receiver is configured to:
receive the further alarm signal; and
measure a further received signal strength with which the further alarm signal reaches the further receiver, and
wherein a transmission signal strength with which the further transmitter transmits the further alarm signal is based on the measured received signal strength with which the alarm signal that triggered the transmission of the further alarm signal reached the receiver.

26. The arrangement of claim 25, wherein:
the alarm signal which triggers the transmission of the further alarm signal comprises information about a transmission signal strength of the alarm signal, and
the transmission signal strength of the further alarm signal is equal to the transmission signal strength of the alarm signal.

27. The arrangement of claim 21, wherein:
the evaluation unit is configured to:
calculate an averaged attenuation,
wherein the averaged attenuation is an average of the attenuations of:
several alarm signals of the sequence of alarm signals, or
several alarm signals that have reached the receiver in a sliding time window; and
select one of the two or more given possible alarm intensities based on the calculated average attenuation,
wherein the evaluation unit calculates the averaged attenuation using:
a median of the attenuations of the several alarm signals of the sequence of alarm signals, or
a median of the attenuations of the several alarm signals that have reached the receiver in a sliding time window.

28. The arrangement of claim 21, wherein:
the arrangement is configured to transmit the sequence of alarm signals from the transmitter to the receiver by using a transmission protocol,
wherein the transmission protocol used specifies a maximum transmission power,
wherein the specified maximum transmission power is at most 100 mW.

29. The arrangement of claim 21, wherein:
the arrangement is configured in such a way that, based on the receiver receiving, for the first time after the start of use of the arrangement, an alarm signal transmitted by the transmitter, the evaluation unit:
determines an initial attenuation that acts on the alarm signal that the receiver received as a first alarm signal from the transmitter; and
generates a computer-executable assignment rule,
wherein the computer-executable assignment rule assigns to each attenuation from a range of possible attenuations that can act on a transmitted alarm signal one of the two or more given possible alarm intensities,
wherein the evaluation unit uses the determined initial attenuation and the specified number of the two or more given possible alarm intensities to generate the assignment rule,
wherein the arrangement is further configured such that, in the case that the receiver receives, during the use of the arrangement, a further alarm signal of the sequence of alarm signals, if a determined attenuation of the further alarm signal lies within the range of the possible attenuations, the evaluation unit selects one of the two or more given possible alarm intensities by applying the generated assignment rule to the determined attenuation of the further alarm signal.

30. The arrangement of claim 29, wherein:
the two or more given possible alarm intensities are given such that:
a first set of alarm intensities of the two or more given possible alarm intensities are weaker alarm intensities compared with a remaining second set of alarm intensities of the two or more given possible alarm intensities,
wherein if the alarm is issued with an alarm intensity given by the first set of alarm intensities, the alarm is perceived by a given person:
as weaker than if the alarm were triggered with one of the remaining second set of alarm intensities,
wherein the assignment rule is configured in such a way that the assignment rule assigns one of the first set of alarm intensities to the initial attenuation.

31. The arrangement of claim 30, wherein:
an order is specified among the two or more given possible alarm intensities,
wherein the specified order is based on a strength with which a person perceives an alarm issued by the alarm unit,
wherein the first set of alarm intensities are the first alarm intensities of this order, and
wherein the assignment rule is configured in such a way that, as the attenuation decreases, the assigned alarm intensity increases or remains the same in accordance with the specified order.

32. The arrangement of claim 29, wherein:
the arrangement is configured in such a way that, based on the receiver receiving, for the first time, an alarm signal which has been transmitted by the transmitter, the evaluation unit:
based on the determined initial attenuation and based on the two or more given possible alarm intensities, generates an upper attenuation threshold, and
generates the assignment rule in such a way that the range of the possible attenuations has the upper attenuation threshold as an upper limit,
wherein the arrangement is further configured such that, in case that the receiver receives the further alarm signal, if the determined attenuation is greater than or equal to the upper attenuation threshold, the controller controls the alarm unit in such a way that the alarm unit does not issue an alarm or stops issuing an alarm in response to the control.

33. The arrangement of claim 21, wherein:
the arrangement further comprises an alarm detector,
wherein the alarm detector is assigned to the first person,
wherein the alarm detector is configured to detect an indication that the first person needs to be rescued,
wherein the controller is configured, in response to the detection of the indication, to cause the rescue signal generator to generate the rescue signal in such a way that the generated rescue signal includes information indicating that the first person needs to be rescued.

34. The arrangement of claim 21, wherein:
the alarm unit comprises a controllable vibration motor,
wherein the controller is configured to control the vibration motor, wherein the vibration motor is configured to issue the alarm by generating vibrations as, wherein the vibrations can be perceived by a given person with at least one of the body of the given person and the hearing of the given person,
wherein the vibration motor is configured such that the generated vibrations depend on the control,
wherein the vibration motor is further configured such that the vibration motor:
vibrates with at least one of a frequency, an amplitude, and a vibration duration, based on the selected alarm intensity, or
vibrates in a pulsed manner and at least one of a pulse duration and a distance between two consecutive pulses is based on the selected alarm intensity.

35. A system comprising:
an arrangement comprising:
a rescue signal generator;
a transmitter;
a receiver;
an alarm unit;
a signal-processing evaluation unit; and
a signal-processing controller,
wherein the transmitter:
is assigned to a first person; and
is designed to be worn by the first person on his/her body,
wherein the rescue signal generator is configured:
to generate a rescue signal; and
to cause the rescue signal to be transmitted to the transmitter,
wherein the transmitter is further configured to:
generate, in response to receiving the rescue signal, a sequence of alarm signals; and
transmit the sequence of alarm signals,
wherein the receiver is configured to:
receive an alarm signal of the sequence of alarm signals; and
measure a received signal strength as a signal strength with which the alarm signal reaches the receiver,
wherein the alarm unit is configured to:
be worn by a second person on his/her body; and
issue an alarm, wherein the alarm comprises at least one of an acoustic alarm or a haptic alarm in such a way that the second person, carrying the alarm unit on his/her body, perceives the alarm,
wherein the alarm unit is further configured to:
be controlled; and
issue the alarm, based on the control, in one of two or more given possible alarm intensities,
wherein the controller is configured to control the alarm unit,
wherein the evaluation unit is configured to:
determine, based on the measured received signal strength of the received alarm signal, an attenuation acting on the alarm signal on the path from the transmitter to the receiver; and
select, based on the determined attenuation of the alarm signal, one of the two or more given possible alarm intensities, and
wherein the arrangement is configured such that, based on the receiver receiving the alarm signal, the steps are performed that:
the receiver measures the received signal strength of the alarm signal;
the evaluation unit determines, based on the measured received signal strength, the attenuation acting on the alarm signal and selects, based on the determined attenuation, the one of the two or more given possible alarm intensities; and
the controller controls the alarm unit in such a way that the alarm unit issues, in response to the control, the alarm with the selected alarm intensity; and
a protective device,
wherein the protective device is designed to protect and surround the head of the second person in such a way that an interior space occurs between the head and an inner surface of the protective device, and
wherein the alarm unit is arranged in the interior space.

36. The system of claim 35, wherein:
the alarm unit comprises a controllable vibration motor,
wherein the controller is configured to control the vibration motor,
wherein the vibration motor is configured to issue the alarm by generating vibrations, wherein the vibrations can be perceived by a given person with at least one of the body of the given person and the hearing of the given person,
wherein the vibration motor is configured such that the generated vibrations depend on the control,
wherein the vibration motor is further configured such that the vibration motor vibrates in at least one of the following ways:
with at least one of a frequency, an amplitude, and a vibration duration, based on the selected alarm intensity, and
in a pulsed manner, wherein at least one of a pulse duration and a distance between two consecutive pulses is based on the selected alarm intensity,
wherein the vibration motor is arranged such that the vibrations generated by the vibration motor are perceived by the second person in at least one of:
haptically, on the head, and
acoustically.

37. A method performed using an arrangement:
wherein the arrangement comprises:
a rescue signal generator;
a transmitter;
a receiver; and
an alarm unit,
wherein the alarm unit is configured to issue an alarm comprising at least one of an acoustic alarm and a haptic alarm,
wherein the alarm unit is configured to:
be controlled;
issue, in response to being controlled, the alarm such that a second person, wearing the alarm unit on his/her body, perceives the alarm, and
issue the alarm, based on the control, in one of two or more given possible alarm intensities,
wherein the method is carried out while:
the transmitter is assigned to a first person; and
the first person wears the transmitter,
wherein the method is carried out while the second person, who is not the first person, is wearing the alarm unit on his/her body,
wherein the method comprises the steps that the rescue signal generator:
generates a rescue signal; and
causes the rescue signal to be transmitted to the transmitter,
wherein, based on the transmitter receiving the rescue signal:
the transmitter generates a sequence of alarm signals; and
the transmitter transmits the sequence of alarm signals,
wherein, based on the receiver receiving the alarm signal:
the receiver measures a received signal strength as a signal strength with which the alarm signal reaches the receiver;
based on the measured received signal strength of the alarm signal, an attenuation that acts on the alarm signal on the path from the transmitter to the receiver is determined;
based on the determined attenuation of the received alarm signal, one of the two or more given possible alarm intensities is selected; and
the alarm unit is controlled in such a way that the alarm unit, in response to the control, issues an alarm with the selected alarm intensity, wherein the alarm is at least one of acoustically perceptible or haptically perceptible.

38. The method of claim 37, wherein:
the method further comprises the steps of automatically, based on the event that the receiver, for the first time after the start of use of the arrangement, receives an alarm signal transmitted by the transmitter:
determining an initial attenuation, wherein the initial attenuation is an attenuation that acts on the given alarm signal that the receiver received as the first alarm signal from the transmitter; and
generating a computer-executable assignment rule, the assignment rule assigning to each attenuation from a range of possible attenuations that can act on the given alarm signal one of the two or more given possible alarm intensities,
wherein the determined initial attenuation and a specified number of the two or more given possible alarm intensities are used to generate the assignment rule, and
based on the receiver receiving, during the use of the arrangement, a second alarm signal of the sequence of alarm signals triggers a step that:
if a determined attenuation of the second alarm signal lies within the range of the possible attenuations, while the one of the two or more given possible alarm intensities is selected, the generated assignment rule is applied to the determined attenuation of the given alarm signal.

39. The method of claim 38, wherein:
based on the receiver receives an alarm signal, sent by the transmitter, for the first time additionally triggers the steps that:
an upper attenuation threshold is generated based on the determined initial attenuation and based on the two or more given possible alarm intensities; and
the assignment rule is generated in such a way that the range of possible attenuations has the upper attenuation threshold as an upper limit; and
based on the receiver receiving an additional alarm signal triggers the step that:
if the determined attenuation is greater than or equal to the upper attenuation threshold, the alarm unit is controlled in such a way that the alarm unit does not issue an alarm or stops issuing an alarm in response to the control.

40. The method of claim 37, wherein:
the alarm unit comprises a controllable vibration motor,
the step of issuing the alarm, by the alarm unit and in response to the control, with the selected alarm intensity comprises a step that the vibration motor is controlled and generates, as issuing the alarm, vibrations that can be perceived by a person with at least one of the body or the hearing,
wherein the generated vibrations depend on the control, and
wherein the vibration motor vibrates in at least one of the following ways:
with at least one of a frequency, an amplitude, and a vibration duration, based on the selected alarm intensity, or
in a pulsed manner, wherein at least one of a pulse duration and a distance between two consecutive pulses depends on the selected alarm intensity.

41. The method of claim 37, wherein:
the arrangement further comprises an alarm detector,
wherein the method is carried out while the alarm detector is assigned to the first person,
wherein the method further comprises a step that:
the alarm detector monitors whether there is an indication that the first person needs to be rescued, and
wherein, based on the alarm detector detecting the indication, the rescue signal generator:
generates the rescue signal; and
causes the rescue signal to be transmitted to the transmitter.
